(19) United States
(12) Patent Application Publication
(10) Pub. No.: US 2005/0222928 A1
(43) Pub. Date: Oct. 6, 2005

(54) Systems and methods for investigation of financial reporting information

(75) Inventors: David Steier, Palo Alto, CA (US); Sheldon Laube, Los Altos, CA (US); Krishna Kumaraswamy, Mountain View, CA (US)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(73) Assignee: PricewaterhouseCoopers LLP

(21) Appl. No.: 10/819,453

(22) Filed: Apr. 6, 2004

(51) Int. Cl. G06F 17/60

(52) U.S. Cl. 705/35

(57) ABSTRACT

Financial data including general ledger balances and underlying journal entries are examined to determine whether risks of material misstatement due to fraudulent financial reporting can be identified. The financial data is analyzed statistically and modeled over time, comparing actual data values with predicted data values to identify anomalies in the financial data. The anomalous financial data is then analyzed using clustering algorithms to identify common characteristics of the various transactions underlying the anomalies. The common characteristics are then compared with characteristics derived from data known to derive from fraudulent activity, and the common characteristics are reported, along with a weight or probability that the anomaly associated with the common characteristic is an identification of risks of material misstatement due to fraud. Large volumes of financial data are therefore efficiently processed to accurately identify risks of material misstatement due to fraud in connection with financial audits, or for actual detection of fraud in connection with forensic and investigative accounting activities.

### FIELD OF THE INVENTION

The field of the invention relates to financial accounting and auditing, and more particularly to systems and methods of identifying risks of material misstatement due to fraudulent financial reporting in connection with a financial audit, and to systems and methods of investigating financial fraud with regard to forensic and investigative accounting.

### BACKGROUND OF THE INVENTION

Statement on Auditing Standards (SAS 99), issued by the American Institute of Certified Public Accountants (AICPA) in October, 2002, has had an impact on financial auditors in connection with identifying risks of material misstatement due to fraud. In this regard, auditors are now more likely to consider using fraud-oriented analytic and substantive tests, in particular, on journal entries and other adjustments to the books of an audit client.

Currently, auditors seeking to identify risks of material misstatement due to financial reporting fraud engage in time and resource-intensive searches and investigations of their audit client. For example, the auditor may manually review the financial reports of the client to identify suspicious data. The auditor may then interview employees of the client, and/or search selected client records, to determine the reasons for any anomalous data. This classic forensic investigation practice is often times costly and time consuming.

Also, financial and professional services firms perform forensic and investigative accounting, as part of specialized client engagements independent of financial audit engagements. Investigation and detection of financial fraud is often part of the focus of such engagements, and enhancements to the tools and methodologies currently available would be beneficial.

The role of information technology in today's accounting systems has lead to computer-assisted audit techniques (CAATs) for extraction and analysis of large volumes of data. This obviates or supplements some of the manual review of the audit client's accounting data in connection with an audit, or the investigative accounting client's accounting data in connection with a forensic accounting investigation. However, the effort required to apply such CAATs, especially for the extraction and normalization of large amounts of data, and to have auditors review the results of the CAATs, has also limited the applicability of such techniques. CAATs which rely upon a purely statistical analysis of a company's accounting data, to spot anomalous data, can extract and analyze a large amount of data. However, these CAATs report every anomalous data point, whether that data point is relevant to identification of risks of material misstatement due to fraud or not. This results in an over-reporting of anomalous data to the auditor, who must then investigate each and every anomaly using the classic forensic investigation practice discussed above. Similarly, conventional CAATs, as described above, also have limitations when used as tools in connection with forensic and investigative accounting activities, where efforts are made to investigate and detect fraud.

Conventional CAATs work at either of two levels, the financial statement level, or the underlying business transaction level. CAATs applied to the top-level financial statements, such as income statements, balance sheets, statements of stockholders' equity, statements of cash flows, etc., generally calculate simple ratios to be used in preliminary analytic review. For example they might calculate the days sales outstanding (“DSO”, which is the ratio of yearly net sales to receivables, divided by 365), because an increase in DSO may be indicative of premature revenue recognition, a form of financial statement fraud. While useful indicators of risk of material misstatement due to fraud, CAATs applied at the financial statement level are only preliminary indicators. These CAATs may report anomalies that may exist for a number of reasons besides risk of material misstatement due to fraud. Furthermore, these CAATs may be foiled by manipulation of the underlying accounts to preserve the top-level ratios in the financial statements.

At the finer-grained transaction level, conventional CAATs may perform simple reviews of the journal entries and general ledger balances that go into a typical accounting system. For example a common test is to screen for unusually large number of “round dollar amounts” ($5000 instead of $4893) appearing as sums of other numbers. These CAATs are also likely to flag entries that do not indicate risk of material misstatement due to fraud. Furthermore, the simple CAATs applied in practice are easily foiled by sophisticated perpetrators.

For certain types of fraud outside of the financial auditing and accounting fields, which do not require analysis of a large volume of data, it is possible to design a rule-based artificial intelligence (AI) system to analyze the data and look for patterns in the data. These sorts of AI systems are currently used to detect fraudulent usage patterns for credit cards and telephone billing. In these areas, the amount of data that needs to be examined is relatively small, and the number of rules that the AI system needs to apply is also relatively small. For example, to detect fraudulent use (or theft) of a credit card, the only data that need be examined is the charging patterns of a single credit card. The rules are likewise fairly simple, looking for things such as usage in foreign countries, high charging volume, usage in certain types of stores, etc. An example of an AI-based tool used to detect credit card fraud is discussed in U.S. Published Patent Application No. U.S. 2002/0133721, which application is hereby incorporated herein by reference, in its entirety.

These rule-based systems, however, cannot scale up to handle the large volumes of data in a typical business entity's accounting system that need to be analyzed as part of a financial audit, in order to identify risks of material misstatement due to fraud. The rule-based systems cannot handle the typically millions of data points that need to be analyzed and correlated with each other. The human programmers required to maintain rule-based systems are generally not capable of managing a system that contains more than about 500-1000 rules. The programmers are unable to prune outmoded rules or add new rules fast enough to keep up with changes in accounting practices, nor are they able to modify and update the rules present in the system quickly enough. For example, as the business entity's business plan changes or the business entity merges with another business entity, or simply as the personnel in the business entity change, the parameters of the rule-based system would have to change to keep up with the changes in the business entity. The programmers are also unable to design a detailed enough rules system for such large data collections. Also, given that each business entity is different from one another, many of the rules cannot be used to analyze more than one business entity's data, thus necessitating a different set of rules to be created for each business entity that will be analyzed. Given that a public financial auditing firm may be responsible for auditing thousands if not tens of thousands of business entities in a year, rules-based systems quickly become unmanageable.

Therefore, in the financial audit context it would be useful to have a CAAT that identifies risks of material misstatement due to fraud, which is capable of analyzing large volumes of data, yet requires few enough resources such that the CAAT may be routinely applied to all audits conducted, not just to those audits where a high risk of material misstatement due to fraud has already been identified. Even knowledge of the mere existence of such risk screening tests, without any knowledge that the tests are being used on any particular business entity's accounting data, could act as a deterrent to those contemplating engaging in fraudulent acts. Similarly, it would be useful in the forensic and investigative accounting field to have a CAAT that is useful in investigating and detecting actual financial fraud while making efficient use of human and technical resources and tools in connection with such investigation.

### SUMMARY OF THE INVENTION

In an aspect of an embodiment of the invention, financial data is analyzed to identify anomalous data.

In another aspect of an embodiment of the invention, the anomalous data is analyzed to identify a characteristic of the anomaly.

In another aspect of an embodiment of the invention, the characteristic is compared with a characteristic of data from a second source, where fraud was present.

In another aspect of an embodiment of the invention relating to a financial audit, risks of material misstatement due to fraud are detected by drawing a correlation between the characteristic of the anomaly and a corresponding characteristic of the data from the second source, where fraud was present.

In another aspect of an embodiment of the invention, statistical analysis of financial data is combined with artificial intelligence analysis of the financial data.

In another aspect of an embodiment of the invention, journal entries are analyzed to identify anomalies.

In another aspect of an embodiment of the invention, general ledger balances are analyzed to identify anomalies.

In another aspect of an embodiment of the invention, clustering algorithms are used to extract common characteristics of groups of anomalous data items.

In another aspect of an embodiment of the invention, characteristics of transactions in accounts on dates where an anomaly has been identified are extracted by inducing decision trees to discriminate between such anomalous transactions and transactions in accounts and on days where no anomaly has been identified.

In another aspect of an embodiment of the invention, time-series data are created from general ledger balance information and journal entry information and analyzed to identify anomalies.

In another aspect of an embodiment of the invention, multivariate linear regression techniques are used to calculate predicted values for a time series, and the predicted values are compared to the actual values, to identify anomalies.

In another aspect of an embodiment of the invention relating to forensic or investigative accounting, a likelihood of financial reporting fraud is detected by correlating the characteristic of the anomaly and a corresponding characteristic of the data from the second source, where fraud was present.

### BRIEF DESCRIPTION OF THE DRAWINGS

In order to better appreciate how the above-recited and other advantages and objects of the present inventions are obtained, a more particular description of the invention briefly described above will be rendered by reference to specific embodiments thereof, which are illustrated in the accompanying drawings.

FIG. 1 depicts a receipt for a business transaction.

FIG. 2 depicts a partial listing of accounts for a business entity.

FIG. 3 depicts a partial listing of journal entries in the accounting system of a business entity.

FIG. 4A depicts a trial balance taken from the general ledger in the accounting system of a business entity.

FIG. 4B depicts a second trial balance taken from the general ledger in the accounting system of a business entity.

FIG. 5 depicts in a simplified form the relationship among various levels of details in the accounting system of a business entity.

FIG. 6 depicts a method of identifying risks of material misstatement due to fraud, according to an embodiment of the invention.

FIG. 7 depicts a graph used by a clustering algorithm to identify risks of material misstatement due to fraud, according to an embodiment of the invention.

FIG. 8 depicts a method of identifying such risks, according to an alternate embodiment of the invention.

FIG. 9 depicts a method of identifying such risks, according to another alternate embodiment of the invention.

FIG. 10 depicts a system for identifying such risks, according to an embodiment of the invention.

### DETAILED DESCRIPTION OF THE PREFERRED EMBODIMENTS

The bookkeeping operations of a business entity or other enterprise revolve around the recording process, where the evidence of business transactions is recorded in a form that can ultimately be summarized and used by management, investors, regulators, shareholders, auditors, etc. When a business transaction occurs, some sort of evidence of the transaction is recorded. This may be a receipt, a purchase order, an e-mail, a cancelled check, a wire transfer record, or any other form of recording evidence of business transactions. The business transaction may be a transaction with an external entity, such as a supplier, vendor or customer, or it may be an internal transaction or adjustment, for example to ensure that revenue and expenses are recognized in the period they actually occurred, or to reflect a change in accounting practices, re-organization of a company's accounts, or for any other reason why a company may need to make internal transactions or adjustments to its books.

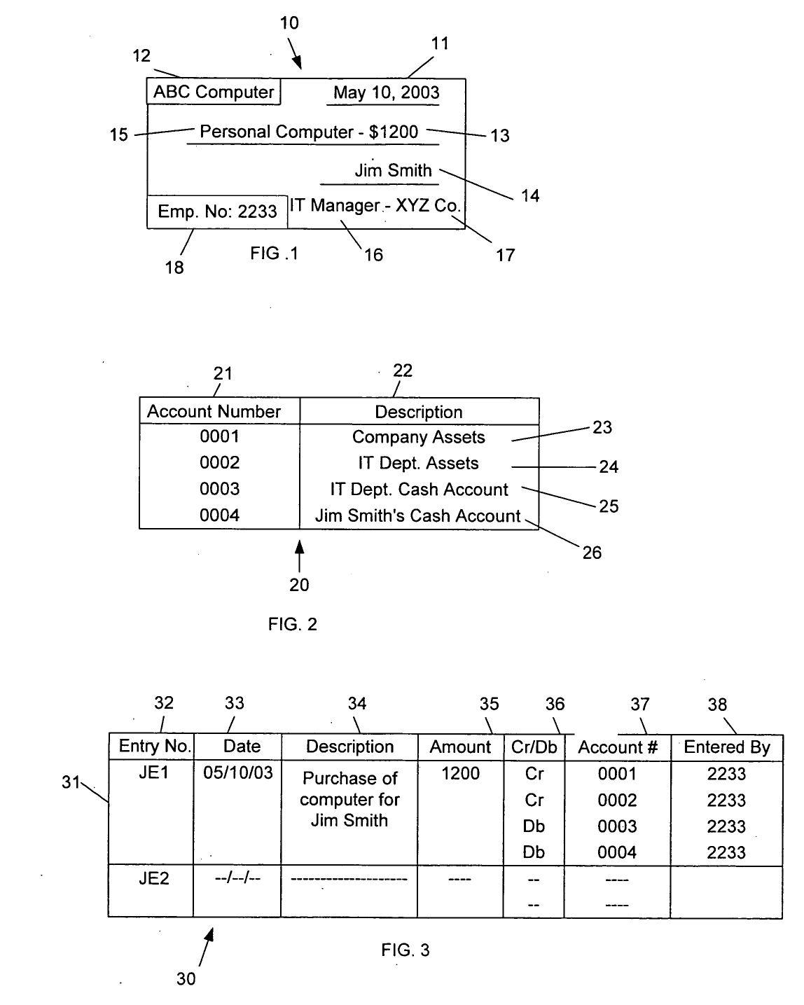

A transaction for a simplified accounting system is shown in FIG. 1. Computerized accounting systems used in practice often employ more complex methods of tracking transactions and accounts, such as using sub-ledgers, using additional fields associated with each transaction, using other ways of classifying transactions, etc. The methods of embodiments of the invention are also applicable to these more complex accounting systems. This transaction (FIG. 1) is a receipt for purchase of a computer. The receipt 10 includes information identifying the transaction date 11, the vendor 12, the transaction amount 13, the purchaser 14, the purchased item 15, the purchaser's position or title 16 within the business entity, the name 17 of the business entity, and the employee number 18 of the person who entered the transaction into the accounting system. This receipt shows that the computer was purchased on May 10, 2003, by Jim Smith, the IT Manager for XYZ Co., from ABC Computer, Inc. The transaction was recorded by an employee with the employee number “2233”. This transaction is received by the accounting department of XYZ Co., and it is analyzed by the accounting department staff to determine the impact this transaction will have on the accounts of the business entity.

A business entity may keep separate accounts for all of the various categorizations the business entity wishes to break out and record its financial data. For example, turning to FIG. 2, a partial listing of sample accounts for XYZ Co. is shown. The account list 20 includes account numbers 21 and account descriptions 22. The account numbers 21 are used by the business entity to easily identify and track the accounts used to record the business transactions. The account descriptions 22 are used to assist human users of the business entity's accounting system in understanding what purpose each account serves. The account list 20 includes four accounts. First is the Company Assets account 23. This account tracks all assets that the business entity acquires or sells, as well as manages depreciation (loss in value over time) of these assets. Second is the Information Technology (IT) Department's asset account 24. This account serves a similar purpose to the Company Assets account 23, but it only tracks assets attributable to the IT department. Third is the IT Department Cash account 25. This account serves to keep track of the amount of money the IT department has available to spend. Every time the IT department spends money, the amount the department spends is deducted from the IT Department Cash account 25. Likewise, every time the business entity decides to fund the IT department, the IT Department Cash account 25 is credited with an additional amount. Last is Jim Smith's Personal Cash account 26. This account serves a similar purpose to the IT Department Cash account 25, but it only tracks the amount of money available for Jim Smith to spend. The example accounts discussed above for the example company XYZ Co. are presented to aid the discussion of embodiments of the invention. There are a wide variety of different ways a company could choose to organize its accounting system. The particular details of how a company organizes its accounting system are design choices and are not critical to the disclosed embodiments of the invention.

When a business transaction occurs, it is analyzed to determine its debit and credit effect on specific accounts of the business entity, and is recorded in chronological form in a journal. The content of journal entries varies from business entity to business entity, but will typically contain at least the date of the transaction, the accounts to be debited and credited, and an explanation of the transaction. There may be additional data recorded, such as the time of day of the transaction, the identity of the person who made the transaction, the identity of the person who recorded the transaction into the journal, the location where the transaction was entered into the journal, etc.

When the receipt 10 (of FIG. 1) is received by the accounting department of XYZ Co., the receipt is processed by the accounting staff, and a journal entry for the transaction is entered into the journal for XYZ Co. Turning to FIG. 3, a journal 30 showing the journal entry 31 for the transaction 10 is shown. The journal entry includes an identifier 32, a transaction date 33, a transaction description 34, an amount 35, a credit/debit indicator 36, an account 37 against which to apply the journal entry 31, and a user ID field 38 that identifies who entered the data into the journal. Depending on the specifics of the accounting system, the accounting staff may enter a separate journal entry 31 for each account to be credited/debited, or alternatively there may be a single journal entry 31 for the transaction, recording all of the accounts to be credited/debited. Depending on the specifics of the accounting system, other information may be stored in the journal 30, such as the name of the person involved in the transaction, the name of the person entering the journal entry, or any of the other information discussed above.

The accounting staff examines the receipt 10, and notes that it is for the purchase of a computer, which has become an asset of the company. Therefore, the accounting staff logs a credit to the Company Assets account 23 in the amount of $1200, the value of the computer. Similarly, the accounting staff notes that the computer was purchased for the IT department, and logs a credit to the IT Department Assets account 24. Since the computer was purchased for the IT department, this expense must come out of the IT department's cash account. Therefore, the accounting staff logs a debit from the IT Department Cash account 25. Similarly, since the computer is for Jim Smith's use, the accounting staff debits Jim Smith's Personal Cash account 26. The accounting staff processes every business transaction of the business entity in a similar manner, by entering journal entries for every external and internal transaction, crediting and debiting the accounts of the business entity as needed to reflect the impact of each transaction on the books of the business entity.

The sum total of these journal entries are periodically posted to the business entity's accounts, where the account balances in each account are adjusted. These account balances are accumulated in a general ledger, which shows the balances of every account in the business entity. The general ledger is an aggregation of the journal entries, sorted by account. Since the business entity is constantly receiving and recording business transactions into the journal and the journal entries are periodically posted to the accounts in the general ledger, the general ledger balances change over time. When someone is interested in viewing the general ledger information, the person will extract a trial balance from the general ledger, which lists the accounts and their balances at a particular point in time.

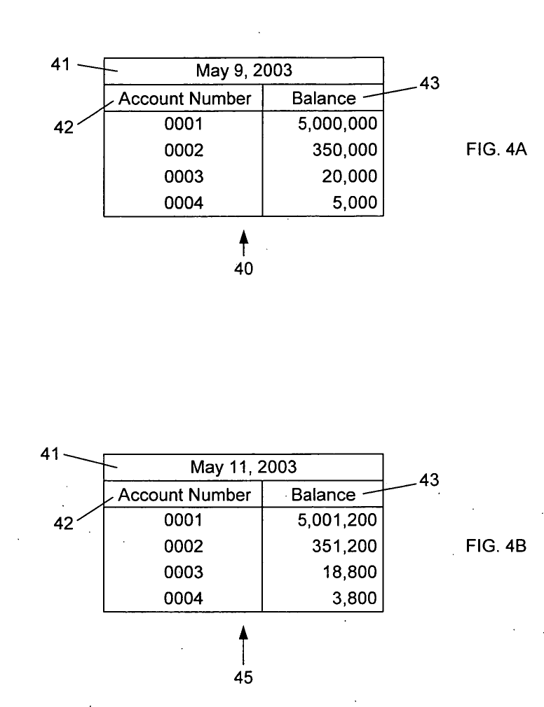

Turning to FIG. 4A-4B, two trial balances for the general ledger of XYZ Company are shown. FIG. 4A shows a trial balance 40 taken prior to the posting of the transaction 10 to the business entity's accounts, and FIG. 4B shows a trial balance 45 taken after the transaction 10 has been posted to the business entity's accounts. Turning to FIG. 4A, the trial balance 40 reflects a balance in the Company Assets account 23 (acct. # 0001) of $5,000,000. The trial balance reflects a balance in the IT Department Assets account 24 (acct. # 0002) of $350,000. Similarly, the IT Department Cash account 25 has a balance of $20,000, and Jim Smith's Personal Cash account 26 has a balance of $5,000. Turning to FIG. 4B, the trial balance 45, taken after the journal entry 31 has been posted to the accounts, shows a higher balance of $5,001,200 in the Company Assets account 23, to reflect the increase in the company's total assets caused by the purchase of the computer. Similarly, the IT Department Assets account 24 has increased by $1,200, reflecting the purchase of the computer. The IT Department Cash account 25 has been reduced by $1,200, to reflect the purchase of the computer using IT department funds. Similarly, Jim Smith's Personal Cash account 26 has been reduced by $1,200, reflecting that the computer purchase came out of his personal portion of the IT department funds. Trial balances such as these may generally be taken at any time, and function as a snapshot of the company's financial position.

When these trial balances have been updated to reflect any pertinent adjustments, such as depreciation of assets, or accruals (revenues earned but not yet received or recorded, and expenses incurred but not yet paid or recorded), they can then be used to prepare financial statements, which are consolidated reports of activity across many accounts. For example, financial statements may include income statements, balance sheets, statements of stockholders' equity, statements of cash flows, etc. It is these financial statements that are typically made available to investors, regulators, and, for publicly held entities, the general public.

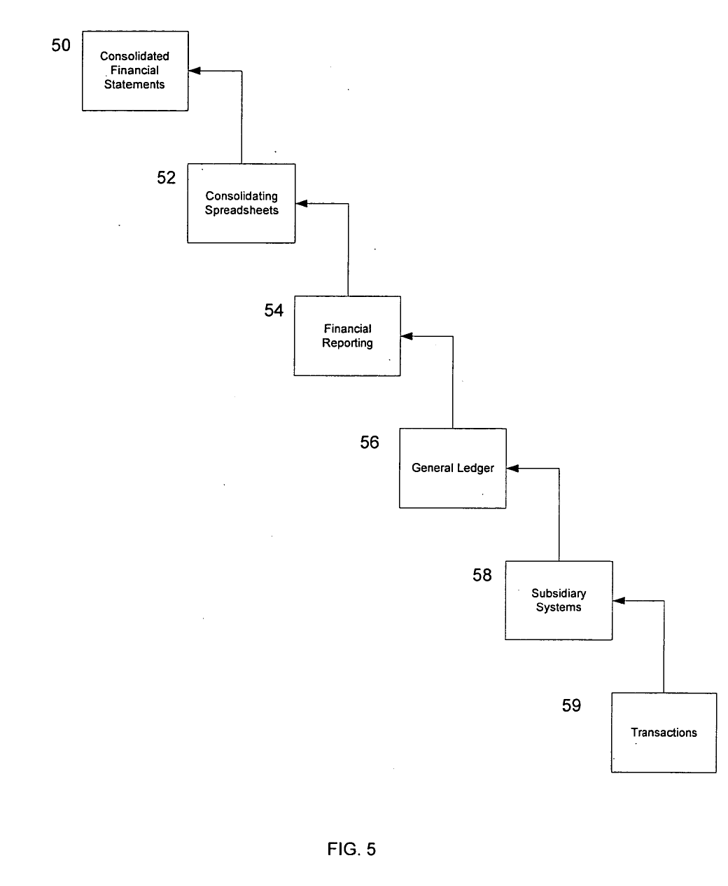

In summary, turning to FIG. 5, the roll-up mapping of a typical financial system implemented in a large company includes at the highest level the consolidated financial statements 50. These consolidated financial statements 50 can be broken down into the various reporting entities that comprise the consolidated totals reported on the consolidated financial statements 50. For example, a large company may have many reporting entities, such as divisions or subsidiaries, each of which maintains separate accounting systems, and reports financial information up to the consolidated financial statements 50.

The entries in the consolidated financial statements 50 can be generated from the financial statements for each reporting entity via various different methods. One such method through use of consolidating spreadsheets 52, which gather together corresponding entries from the financial statements and tabulate the consolidated entries for the consolidated financial statements 50. Alternatively, the company may use any of a variety of software applications which automate this process.

The financial statements for each reporting entity are generated by consolidating the balances in the various accounts maintained by the entity's accounting system, and rolling up those consolidated balances to the various line items of the financial statements, using financial reporting 54. For example, a cash line item of a financial statement may include the balances from several accounts, such as Petty Cash, Checking, Payroll, etc., all of which are rolled up to the cash line item via financial reporting 54.

Account balances are tracked in the general ledger 56, which is composed of postings from various subsidiary systems 58. For example, the subsidiary systems 58 may include systems which account for Revenue/Receivables, Purchases/Payables, Payroll, Fixed Assets, Inventory, and General Journal entries. The subsidiary systems 58 receive transactions 59, which are the lowest level data entered by the accounting staff. The journal entries discussed above are examples of these transactions 59.

Therefore, a consolidated financial statement 50 is a consolidated report of activity that can be traced down to balances in the general ledger 56, and also down to the journal entries or transactions 58 in the journal that affect the balances in the general ledger 56. Since the information reported in the consolidated financial statements 50 is relatively easily traceable back to the information contained in the general ledger 56 and journal entries or transactions 58, someone wishing to falsify information on a consolidated financial statement 50, or otherwise make material misstatements, and make that false information difficult for conventional CAATs to identify, will also typically create falsified entries in the company's general ledger 56 and falsified journal entries 57.

Note that if a perpetrator merely alters two financial statement entries and causes them to balance one another out, without “grounding” the altered financial statement entries in the business entity's general ledger and journal, then there would be a discrepancy between the amount reported on the financial statement and the sum of the underlying ledger balances that went into the financial statement value. This discrepancy would be relatively easy for conventional CAATs to detect.

For example, the “Corporate Assets” line reported on a financial statement is an aggregate sum of many different accounts in the general ledger (i.e. divisional asset accounts, tangible assets, intangible assets, etc). If a perpetrator wanted to increase the value of the assets of the business entity, he could simply alter the “Corporate Assets” line on the financial statement, and make a corresponding alteration in the “Corporate Liabilities” line of the financial statement, (or more likely the “Shareholder Equity” line), such that the assets and liabilities remained in balance. However, such actions could be detected, merely by comparing the “Corporate Assets” line on the financial statement against the sum of all of the various general ledger account balances which were used to derive the aggregate “Corporate Assets” number. Similarly, if the perpetrator altered the general ledger balances without providing corresponding journal entries, then such actions could be detected by merely comparing the general ledger balance for each account with the sum of the journal entries that affect that account. To avoid being easily detected, the perpetrator must fabricate financial data all the way down to the journal entry level.

To identify risks of material misstatement due to fraud, a financial auditor will inspect the financial statement 50 for evidence of such risks, such as to determine whether the company's assets and liabilities match, or to determine if the financial statement 50 correctly report the information contained in the general ledger 57. Only the most simplistic wrongful activities, however, will be discoverable by reviewing financial statements alone. Sophisticated perpetrators have learned how to create financial statements that appear normal, yet conceal evidence of their wrongful acts; for example by grounding the wrongful activity with falsified journal entries, as discussed above. To identify risks of material misstatement due to sophisticated frauds, a financial auditor may drill down into the underlying general ledger information and journal entries, to review these entries for signs of such risks.

Even in cases of sophisticated frauds being perpetrated, with any alterations of the financial statement balances being grounded with falsified journal entries as discussed above, the flows of data through the accounts of a business entity are such that risks of material misstatement due to fraudulent manipulation of the underlying ledger and journal data may be able to be detected, provided sufficient time and resources are used. When a perpetrator makes changes in one or a few balances in an otherwise normal general ledger, these changes will have implications for the other balances. For example, an increase in sales for a business entity implies a corresponding increase in the cost of generating those sales, which is often due to an increase in labor costs, which is correlated with an increase in spending on workers' compensation insurance, and so forth. Similarly, an increase in sales should show a corresponding increase in assets, as the business entity purchases more equipment to handle the additional business. Thus, a perpetrator who wished to falsify the sales figures for a business entity in order to show increased revenue, would likely also have to falsify the figures for the business entity's cost of sales, labor costs, workers' compensation insurance, and a host of other figures. In many instances, these falsified figures would have to be grounded with falsified journal entries. The general ledger of a typical business entity contains so many accounts and records the effects of so many transactions, that it would be difficult for a perpetrator to make significant alterations and still preserve all of the interrelationships between and among the various accounts, as they would exist in normal, non-fraudulent operations.

Therefore, a method that identifies risks of material misstatement due to fraud that examines the journal entries and general ledger account balances underlying a financial statement, in order to detect disruptions of the interrelationships between or among the accounts, should be capable of identifying many such risks which conventional auditing techniques would miss. As noted above, however, conventional CAATs do not attempt to model these interrelationships, in part because they do not allow for the accurate and efficient processing of the volumes of data necessary to be evaluated in order to identify these risks. The CAATs that can process large volumes of data are incapable of accurately identifying such risks, and the CAATs that are capable of accurately identifying such risks are incapable of processing the large volumes of data found in most accounting systems.

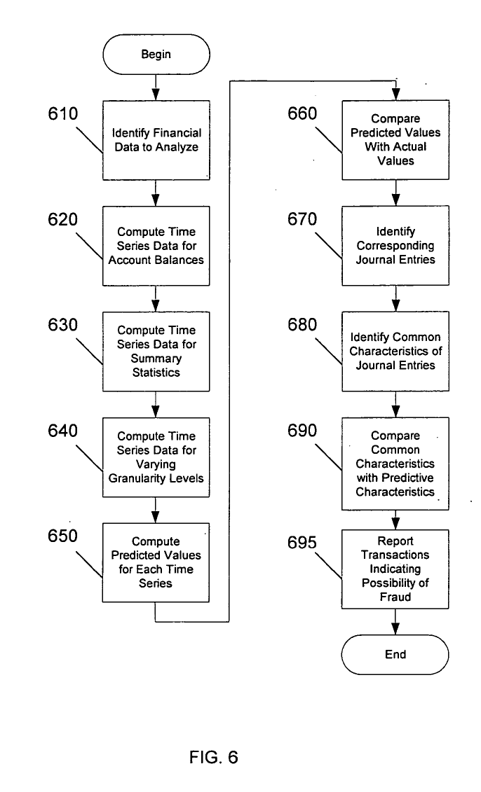

In an embodiment of the invention shown in FIG. 6, a method for identifying risks of material misstatement due to fraud avoids these and other drawbacks to conventional CAATs. The method of FIG. 6 combines statistical analysis techniques with artificial intelligence techniques, in order to identify anomalous data, then identify the reasons why the data is anomalous, and finally to determine if the reasons for the anomaly suggest risks of material misstatement due to fraud. This method may be implemented as a CAAT, in computer software or hardware or a combination of the two.

The method begins at step 610, where the collection of financial data to work on is identified. For example, the CAAT is used on the general ledger account balances and the journal entries from XYZ Company, which is being audited by an auditor using the CAAT. At step 620, using the financial data of XYZ Company, a collection of time series data based on the account balances in the general ledger, gathered over time, is computed. For example, a trial balance is computed for each account in the general ledger, over a series of time intervals, such as daily, weekly, monthly, quarterly, or annually. Additional time series data may be computed for dates of particular interest, including non-continuous dates such as the last day of a reporting period, such as the end of each month, quarter, or year. These time series are used to analyze trends that might otherwise be masked by the data from the rest of the time interval, but when examined in isolation could reveal trends indicative of the presence of risks of material misstatement due to fraud.

At step 630, further time series data is gathered based on other factors, such as various summary statistics for the balances, and the incremental changes to the balances over various time periods, reflected in the general ledger for the same time periods. For example, a monthly time series is generated for the mean balance for each month for each account, over the time period being measured. Time series are also generated for the changes to the balance over each day, week, month, quarter, and year. Similarly, a monthly time series is generated for other statistics, such as the variance among balance values, the minimum and maximum balances, the skewness of the distribution of the balances for the month, and/or the kurtosis of the distribution of the balances for the month. (Skewness is a measure of the asymmetry of a data distribution—the closer the distribution is to the distribution in a symmetric bell-curve, the closer the skewness is to 0). Kurtosis is a measure of how “peaked” the data distribution, “spikes” have higher kurtosis than “plateaus”.) If desired, additional time series data which computes non-linear time series data, such as the square or the cube of the account value, may be computed if it is determined that an analysis of such data may be useful to detect the risks of material misstatement due to fraud. At step 640, additional time series data for the account balances and for the summary statistics on the transaction data are generated, at varying levels of granularity (e.g. yearly, quarterly, monthly, weekly, and/or daily.). Additional time series may be created based on the pairwise correlation among the account balances.

At step 650, the time series data gathered in steps 620-640 is then used to calculate a predicted value for each time series at each point in time, as a function of the past actual values in the time series as well as all of the past and present values of the other account balances at all points in time. These predicted values can be created using a well-known statistical technique known as multivariate linear regression. To briefly summarize this technique, multivariate linear regression is a technique for predicting the present value of a time series of data (such as the monthly account balances and other data collected from the financial data for XYZ Company as discussed at step 620-640 above), using the past values from the same time series, and the past and present values of the other time series. For example, the present value of the company assets account 23 is predicted by computing the past values of the company assets account 23, computing the past and present values for the other accounts 24-26 of XYZ Company, as well as the past and present values of the other time series discussed above, such as the summary statistics. These computed values are each modified by a regression coefficient, which measures the relative contribution of each computed value to the predicted value. Mathematically, the predicted value can be expressed as linear combination of the past values of the target time series and the past and present values of all of the other time series. The equation is as follows, for a time series S₁, at time t:
s₁(t)=a_{1,1}s₁[t−1]+ . . . +a_{1,w}s₁[t−w]+a_{2,0}s₂[t]+a_{2,1}s₂[t−1]+ . . . +a_{2,w}s₂[t−w]+a_{k,0}sₖ[t]+a_{k,1}sₖ[t−1]+ . . . +a_{k,w}sₖ[t−w]
for all t=w+1, . . . , N.

The values a_{k,w} are the regression coefficients for each computed value. The equation may be solved for the regression coefficients using a variety of techniques, such as by using a commercial software package such as SPSS, available from SPSS Inc of Chicago, Ill. Further discussion of multivariate linear regression techniques may be found in B.-K. Yi, N. D. Sidiropoulos, T. Johnson, A. Biliris, H. V. Jagadish and C. Faloutsos, Online Data Mining for Co-Evolving Time Sequences, In Proceedings of the IEEE Sixteenth International Conference on Data Engineering, pages 13-22, 2000, which reference is hereby incorporated herein by reference, in its entirety.

Once each predicted value is computed for each time series at each point in time, then these predicted values are compared to the actual values for each of those time series at each time, at step 660, to identify instances where the actual and predicted values are different. For example, if the predicted value for the Company Assets account 23 for June, 2003 is $5,250,000 but the actual value for the Company Assets account 23 for June, 2003 is $5,100,000, this actual value is flagged as being different from the predicted value. Depending on how many data points the auditor or CAAT wishes to examine, a subset of the data points which differ may be identified instead. For example, the auditor may determine that only the top N cases where the predicted values and the corresponding actual values differed the most are significant enough to be examined. These identified values represent anomalies significant enough to be further investigated. A further indication of an anomalous datapoint is obtained by comparing the coefficients or correlations as discussed above as calculated: if the coefficients or correlations change significantly at some point in time, this may indicate a risk of manipulation of the underlying data. Comparison of the coefficients or correlations as well as the values predicted by the model against the actual value may be done for any or all of the summary distribution statistics discussed above, as well as for the account balances themselves.

Once the anomalous account values (and optionally the anomalous summary statistics or other values examined using the statistical techniques discussed above) have been identified, then at step 670 the journal entries which correspond to the anomalous account balance values (or other values of interest) are identified. For example, the actual closing balance for June, 2003 for the Company Assets account 23 was identified as being anomalous, based on the predicted value for that actual value of that account as computed using the statistical analysis discussed above. Therefore, all of the journal entries for June, 2003 which credited or debited the Company Assets account 23 are then identified for further examination. This examination seeks to identify the reasons why the actual value was different from the predicted value.

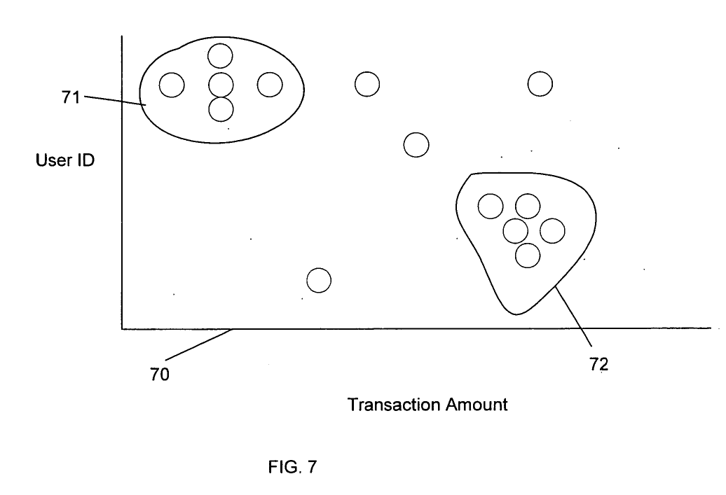

At step 680, once the corresponding journal entries to the anomalous account value are identified, these journal entries are examined and analyzed to identify and learn about the attributes of the journal entries, for example to identify any common characteristics of the transactions or adjustments represented by the journal entries. One way to identify these common characteristics is to run the characteristics of each transaction through a clustering algorithm, for example k-means. For example, all of the transactions identified in step 670 are processed by the clustering algorithm. Clustering algorithms are algorithms which find clusters of similar data points in multi-dimensional data. For example, a clustering algorithm may graph for each transaction the transaction amount 13 against the user ID 18 of the person entering the transaction 14, to identify any patterns of transaction amounts by particular people. A representative graph 70 graphing transaction amount 13 against user ID 18 for each transaction is shown in FIG. 7. Using the graph 70 as an example, the clustering algorithm identifies two clusters 71, 72 where similar transaction amounts were entered by the same person. Other clustering algorithms may graph any or all of the other characteristics of the transactions against each other. For example, a multi-attribute cluster might analyze the transaction category (e.g. credit/debit) against the account age (new/existing) against the form of the transaction (online/Accounts Receivable memorandum/supervisory override/etc.) against the user ID of the person who entered the transaction. An example cluster from such a multi-attribute analysis might group all the entries that match the description “All journal entries that are credits, are not coded as new accounts, are coded as A/R Cash/Credit memo applications, and are entered by user ID 2233.”

Another way to examine and analyze these transactions is to find rules that can be applied to the characteristics of the transactions to distinguish transactions that result in anomalous account values from those that result in non-anomalous account values. The transactions are divided into two sets, anomalous transactions and non-anomalous transactions, depending on whether the transactions are linked to anomalous account balances or other anomalies, as determined above. The two sets of transactions are then input into a decision tree algorithm, for example C5.0, or a rule induction algorithm, that can be used to construct a set of rules that describes each set. For example, the decision tree algorithm processes the set of transactions linked to anomalous account balances or other anomalies identified above. In processing this set, the decision tree identifies a set of rules, such that each transaction meets at least one of the rules. This set of rules is then outputted. A similar set of rules is generated for the transactions linked to non-anomalous account balances or other non-anomalous data. The rules that are output are similar to the common characteristics identified in the descriptions of the clusters above. Once generated, these rules may be more succinct and easier to use, because the rules include only the characteristics relevant to the operation of the rules, i.e. those characteristics in the input transactions that have been determined by the decision tree algorithms to be good predictors of whether the transactions are likely to result in an anomalous account value.

Once the clustering algorithms have identified the common characteristics of the anomalous data points, such as the transactions known to generate the anomalies in the balances, or the decision tree algorithms have identified the set of rules that describe the characteristics of the anomalous data points, then at step 690, the common characteristics of each cluster are compared with characteristics predictive of risks of material misstatement due to fraud, such as the characteristics of clusters of transactions or the set of rules generated from analyses of companies known to be fraudulent. For example, data retrieved from a company where fraud is already known to have existed is analyzed using the method of FIG. 6, to identify anomalous account balances and then identify the common characteristics or set of rules of the underlying transactions which contributed to the anomalous account balances. Alternatively, the financial data from known fraudulent companies may be analyzed using other methods, such as the classical forensic investigative techniques discussed above, to identify such predictive characteristics or sets of rules. As a further alternative, such predictive characteristics or sets of rules which are believed for any other reason (such as experience of an auditor, statements made by fraud perpetrators, common sense, etc.) to be useful to identify risks of material misstatement due to fraud are identified and are used to compare with the common characteristics or sets of rules identified in step 680.

The results of the comparison are reported to the auditor at step 695, giving a higher weighting or priority to those clusters of transactions or balances, or sets of rules, from the data being analyzed which are most similar to the characteristics, clusters of characteristics or sets of rules identified as being predictive characteristics or rules, as discussed above. A higher weighting may also be given to those clusters of transactions or balances or sets of rules which contain a greater mean degree of anomaly. The auditor may then investigate this limited subset of all of the transactions of the business entity, using other methods such as interviewing the people identified by the user IDs 18 who entered the transactions 14 with amounts 15, or reviewing other corporate records about those transactions 14, or any other investigative technique practiced by the auditor.

By following the method of FIG. 6, a CAAT system is able to distill the thousands or tens of thousands of account balances, and the millions, tens of millions, or hundreds of millions of underlying transactions which generate the account balances, down into a manageable number of leads to further investigate to assist in identifying whether there are any risks of material misstatement due to fraud. The method of FIG. 6 avoids the problems with applying a purely statistical analysis to financial data, and the resulting overload of data. The method of FIG. 6 further avoids the problems with applying a purely rules-based artificial intelligence analysis, and the resulting difficulties in scaling and maintaining such a system. By first applying a statistical analysis to identify anomalous data points, and then applying an artificial intelligence analysis to identify common characteristics or sets of rules for the transactions which generated the anomalous data points, and then comparing those identified common characteristics or rules with corresponding characteristics or rules that identify risks of material misstatement due to fraud, the CAAT system of the embodiment of FIG. 6 is able to efficiently and accurately process very large amounts of financial data to identify the most promising subsets of that data which are most likely to be indicators of such risks.

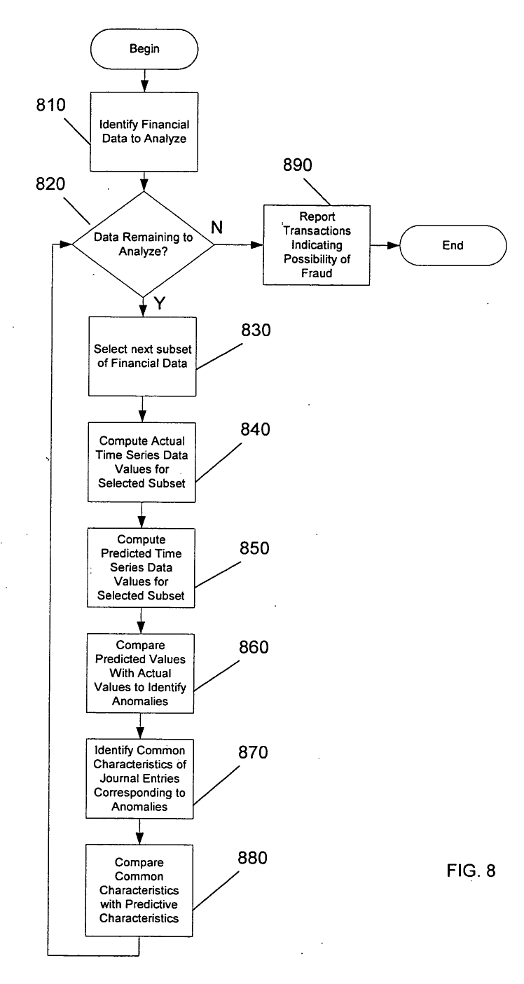

In alternative embodiments, the steps of the method of FIG. 6 may be performed in parallel, or iteratively, or in other different orderings. For example, turning to FIG. 8, a method of identifying risks of material misstatement due to fraud according to an alternative embodiment begins at step 810 by identifying the collection of financial data to be analyzed, such as the accounts of a typical accounting system of a business entity. At step 820, a check is made to determine if there is any financial data remaining to be processed. Assuming there is data remaining to be processed, then at step 830 the next subset of financial data (such as an account in the accounting system) is selected for processing. At step 840, one or more time series are computed as discussed above, for the actual values of the subset of financial data. At step 850, one or more time series are computed as discussed above, for the predicted values of the subset of financial data. At step 860, the predicted and actual values for each point in the time series are compared with each other as discussed above, to identify anomalies in the actual values (e.g. where the actual values differ from the predicted values). At step 870, common characteristics of the anomalous data points are identified, for example by using the clustering algorithms discussed above. At step 880, these common characteristics are compared with predictive characteristics, as discussed above, to identify such potential risks. Control then returns to step 820, where the next subset of data is retrieved for processing by the method. At step 820, the results generated in prior iterations of the method may be used to aid in determining the next subset of data to analyze. For example, if the prior iterations identify in one subset of data a particular characteristic that indicates a risk of material misstatement, then at step 820, another subset of data that also includes that characteristic may be selected as the next subset of data to analyze. Once all of the data has been processed, then at step 890, the identified transactions are reported to the auditor for further action, as discussed above.

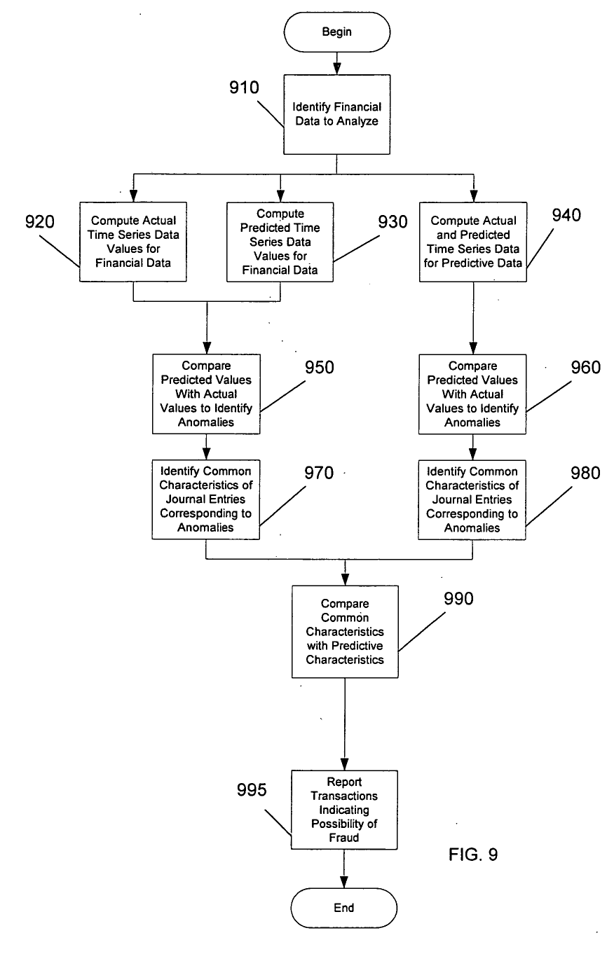

Turning to FIG. 9, an alternative method for identifying risks of material misstatement due to fraud, operating in parallel, is shown. The method begins at step 910, by identifying the collection of financial data to be analyzed, such as the accounts of a typical accounting system of a business entity. Then in parallel, at steps 920, 930 and 940, actual time series data values for the financial data (step 920), predicted time series data values for the financial data (step 930) and actual and predicted values for the predictive data (step 940) are all calculated, in a similar manner as discussed above for FIG. 6. At step 950, the actual and predicted values for the financial data are compared with each other, to identify anomalies. This comparison may be done as soon as steps 920 and 930 begin generating data values. Similarly, at step 960, the actual and predicted values for the predictive data are compared with each other, to identify anomalies. At step 970, the anomalous financial data is processed, for example by the clustering algorithms discussed above, to identify common characteristics of the anomalous data. This clustering analysis may be commenced as soon as step 960 has begun generating anomalous data values. Similarly, at step 980, the anomalous predictive data is processed to identify common characteristics of the anomalous predictive data. At step 990, the common characteristics of the financial data and the anomalous predictive data are compared with each other, to identify possible risks of material misstatement due to fraud in the financial data, as discussed above.

The multivariate regression analysis discussed above may become computationally expensive. The analysis can be optimized using techniques such as incremental calculation, or subset selection. Because of the structure of the time series data, the equation used to calculate the regression coefficients can be expressed as a recursive equation, which allows the computation process to reuse the coefficients calculated for previous values in computing the coefficients for successive values. Therefore, for each coefficient in the equation, only the additional incremental factor above the prior values must be computed (as opposed to re-computing the entire coefficient for every point in time in the time series). This results in a significant gain in efficiency, several orders of magnitude reduction in computation time for an 80 MB dataset, for example.

Furthermore, by selecting a subset of all of the data points in a time series, rather than using the entire time series, the number of terms in the multivariate regression equation can be pruned significantly. Most of the data in the time series other than the time series for which the present value is being computed will be irrelevant in predicting the value of that time series. A measure of expected estimation error can be used to prune the set of time series to a much smaller subset with little cost in accuracy but often greater than one or more orders of magnitude in efficiency. The expected estimation error value is computed instead of computing all of the data in the other time series, which saves significant computation time. As a bonus, this measure of expected estimation error can be calculated incrementally as well, using the incremental calculation methods discussed above.

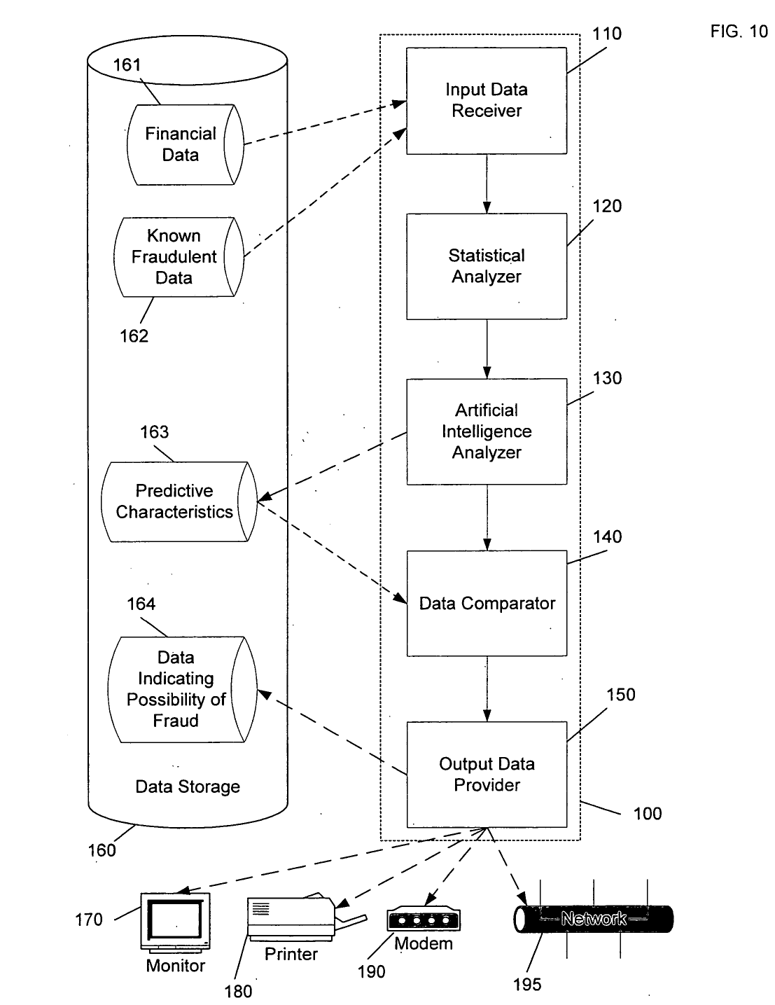

Turning to FIG. 10, a system for identifying risks of material misstatement due to fraud according to an embodiment of the invention is depicted. The system 100 is capable of performing the methods discussed above with reference to FIGS. 6, 8 and 9. The system 100 includes several components including an input data receiver 110, a statistical analyzer 120, an artificial intelligence analyzer 130, a data comparator 140, and an output data provider 150. The system 100 retrieves various data from a data storage device 160 and stores various data in the data storage device 160. The system 100 also provides output data to a variety of devices, such as a monitor 170, a printer 180, a modem 190 or a network 195.

The input data receiver 110 is a component that retrieves input data from the data storage 160, such as the financial data 161 or the known fraudulent data 162. The input data receiver 110 passes this retrieved data on to the statistical analyzer 120. The statistical analyzer 120 is a component that receives input data, for example from the input data receiver 110 and performs a statistical analysis on the data, for example the statistical analyses discussed above with reference to FIG. 6. Once the statistical analyzer 120 has analyzed the data, for example to identify anomalous data points in either the financial data 161 or the known fraudulent data 162, as discussed above, the statistical analyzer 120 forwards the results of the statistical analysis, such as the anomalous data points discussed above, on to the artificial intelligence analyzer 130 and the rest of the components of the system 100.

The artificial intelligence analyzer 130 receives data, such as the anomalous data points discussed above, from the statistical analyzer 120, and analyzes that data using an artificial intelligence technique such as the clustering algorithms, decision tree algorithms or rule induction algorithms discussed above. Once the artificial intelligence analyzer 130 has analyzed the data, for example to identify common characteristics or sets of rules for the anomalous data points identified by the statistical analyzer 120, the artificial intelligence analyzer 130 either writes the resulting data off to the data storage 160, for example as a collection of predictive characteristics (or rules) 163 drawn from the known fraudulent data 162, or it passes the resulting data, for example a collection of common characteristics of the financial data 161, on to the data comparator 140.

The data comparator 140 receives data to be compared from the artificial intelligence analyzer 130, such as the collection of common characteristics of the financial data 161. The data comparator 140 also receives from the data storage device 160 data to compare with the data to be compared, such as the collection of predictive characteristics 163 drawn from the known fraudulent data 162. After receiving these two data collections, the data comparator 140 compares the data collections, for example to identify correlations between the two data collections. These correlations between the two data collections are passed on to the output data provider 150.

The output data provider 150 receives output data from the data comparator 140, such as a list of anomalous data points which have been correlated with known fraudulent data points. The output data provider 150 provides this output data to any of a variety of output devices, such as the data storage device 160 (as data indicating a possibility of fraud 164), the monitor 170, the printer 180, the modem 190, or the network 195. These output devices are adapted to convey the output data to an auditor, such that the auditor may conduct further investigations into the data, as discussed above.

The system 100 may be composed of a set of software code modules adapted to implement the various components discussed above. Alternatively, any or all of the components may be composed of hardware devices adapted to implement the respective components discussed above, such as ASICs, FPGAs, dedicated processors, and any associated wiring or other such components. Alternatively, any combination of hardware, software and/or firmware modules may be used to implement the various components discussed above. The components of the system 100 may be contained within a single hardware device, such as a computer, or the components may be distributed amongst a number of hardware devices, such as a distributed computing system, as desired by a designer of the system 100.

The data storage device 160 may be a single storage device such as a RAM, disk drive, CD-ROM, DVD, etc., or a collection of storage devices such as a NAS, SAN, or RAID array. The data 161-164 may also be stored on different storage devices, as desired by a user of the system 100, such as an auditor. For example, the financial data 161 could be stored on a data storage device located at a business entity's site, while the components of the system 100 are located at an auditor's site. The financial data 161 would then be accessed by the system 100 using, for example, a network connection such as the Internet. Alternatively, the system 100 could be implemented in software on an auditor's personal computer, such as a laptop computer. The laptop computer would contain the system 100, and a data storage device 160 holding the fraud predictive characteristics 163, and optionally the known fraudulent data 162. The auditor would then travel to the business entity's site and connect to the business entity's computer, and financial data 161. Alternatively, the financial data 161 could be downloaded onto a storage medium such as a disk drive, DVD-ROM, etc., and transported to the site where the system 100 is located, for use by the auditor. The auditor would process that data as discussed above to generate the data indicating a possibility of fraud 164, which would be stored either on the business entity's computer or on the auditor's computer.

In the foregoing specification, the invention has been described with reference to specific embodiments thereof. It will, however, be evident that various modifications and changes may be made thereto without departing from the broader spirit and scope of the invention. For example, as has been referenced previously, in the context of specialized forensic investigation and accounting engagements, the methods and systems described herein may also be used to investigate and detect financial fraud. Similarly, the methods and systems of the present invention could be used to analyze financial data for the presence of other phenomena.

The data from business entities where fraud was known to have occurred can be analyzed to identify characteristics that are predictive of actual fraud, in addition to the analysis discussed in detail with respect to various embodiments, which identifies characteristics that are predictive of the presence of risks of material misstatement due to fraud. Therefore, by comparing these fraud predictive characteristics with the anomalous data from the business entity, the presence of actual fraud could be predicted.

For an additional example, financial data from several different entities could be analyzed to detect the presence of money laundering, by comparing the accounts of two or more business entities where money laundering transactions are suspected, with the accounts of business entities known to have participated in money laundering. For example, by processing the financial data through the statistical analysis to identify relationships among the accounts of the two or more business entities and find anomalous data that does not conform to the expected relationships, processing the anomalies through clustering algorithms to identify common characteristics of the anomalies, and then comparing the common characteristics with characteristics known to identify the presence of money laundering.

Other phenomena such as highly taxed, or less taxed companies, unusual amounts of inter-country transfers, or the presence of third-party transactions (off-balance sheet transactions) can also be detected. The specification and drawings are, accordingly, to be regarded in an illustrative rather than restrictive sense, and the invention is not to be restricted or limited except in accordance with the following claims and their legal equivalents.

1. A method for identifying risks of material misstatement due to fraud in the context of a financial audit, comprising:
receiving a plurality of data points, each of the plurality of data points having a value and an associated characteristic,
identifying a plurality of anomalous data points within the plurality of data points,
identifying a common characteristic associated with the anomalous data points,
receiving a predictive characteristic,
comparing the common characteristic with the predictive characteristic, and
determining a risk of material misstatement due to fraud based on the results of the comparison.

2. The method of claim 1, wherein the material misstatement is indicative of fraudulent financial reporting.

3. The method of claim 1, wherein the plurality of data points comprise financial data.

4. The method of claim 3, wherein the financial data comprises general ledger balances.

5. The method of claim 3, wherein the financial data comprises journal entries.

6. The method of claim 1, wherein the plurality of data points comprises greater than one million data points.

7. The method of claim 1, wherein identifying a plurality of anomalous data points comprises comparing for each data point the data point value with a predicted data point value, and selecting as the plurality of anomalous data points those data points whose data point values differ from the predicted data point values by a greater amount than the non-selected data point values differ from the predicted data point values.

8. The method of claim 1, wherein identifying a plurality of anomalous data points comprises using a statistical analysis to identify the plurality of anomalous data points.

9. The method of claim 8, wherein the statistical analysis comprises a time series analysis.

10. The method of claim 9, wherein the time-series analysis comprises a multivariate linear regression.

11. The method of claim 9, wherein the time series comprises a collection of time series data for a time period, based on general ledger balances and journal entries corresponding to the general ledger balances, for the time period.

12. The method of claim 11, wherein the time series data is further based on summary statistics for the general ledger balances.

13. The method of claim 12, wherein the summary statistics comprise one or more of mean, average, variance, min, max, skewness, and kurtosis.

14. The method of claim 11, wherein the time series is based on a correlation between a plurality of general ledger balances.

15. The method of claim 11, wherein the time-series analysis compares a plurality of coefficients for the time series data.

16. The method of claim 11, wherein the time series comprises a collection of time series data for a non-continuous time period.

17. The method of claim 15, wherein the non-continuous time period comprises a plurality of critical dates for a plurality of larger time periods.

18. The method of claim 17, wherein the larger time periods comprise one of months, quarters, or years, and the critical dates comprise the last day of each month, quarter or year.

19. The method of claim 9, wherein the time series is based on a summary of general ledger balances.

20. The method of claim 19, wherein the summary comprises one or more of a yearly, quarterly, monthly, weekly, or daily summary.

21. The method of claim 9, wherein using a statistical analysis comprises calculating a predicted data point value for a data point in the time series as a function of a plurality of past data point values in the time series, as well as one or more past and present values of a second time series at one or more points in time.

22. The method of claim 9, wherein the data point value comprises a regression coefficient.

23. The method of claim 1, wherein identifying a common characteristic comprises using an artificial intelligence analysis to identify the common characteristic.

24. The method of claim 23, wherein the artificial intelligence analysis comprises a clustering algorithm based analysis.

25. The method of claim 24, wherein the data points comprise general ledger balances and the clustering algorithm based analysis comprises:
finding corresponding journal entries for anomalous general ledger balances, and
using a clustering algorithm to identify a common characteristic of the journal entries underlying the anomalous general ledger balances.

26. The method of claim 23, wherein the artificial intelligence analysis comprises a decision tree algorithm based analysis.

27. The method of claim 26, wherein the data points comprise general ledger balances and the decision tree algorithm based analysis comprises:
finding corresponding journal entries for anomalous general ledger balances, and
using a decision tree algorithm to identify a common characteristic of two or more of the journal entries underlying the anomalous general ledger balances.

28. The method of claim 27, wherein the common characteristic is identified by inducing a rule that describes two or more of the journal entries underlying the anomalous general ledger balances.

29. The method of claim 1, wherein the predictive characteristic is derived from a second plurality of data points, the second plurality of data points coming from an entity where fraud has occurred.

30. The method of claim 26, wherein the predictive characteristic is derived by applying the 1) receiving a plurality of data points, 2) identifying a plurality of anomalous data points and 3) identifying a common characteristic steps to the second plurality of data points coming from an entity where fraud has occurred.

31. The method of claim 30, wherein determining a risk of material misstatement due to fraud comprises assigning a relative weight to the common characteristic based on a degree of similarity between the common characteristic and the predictive characteristic.

32. The method of claim 30, wherein determining a risk of material misstatement due to fraud comprises assigning a probability estimate of material misstatement to the common characteristic.

33. A method of identifying risks of material misstatement due to financial reporting fraud, comprising:
(a) receiving a plurality of general ledger balance values and a plurality of journal entries associated with each general ledger balance value, each journal entry having a characteristic;
(b) performing a multivariate regression analysis on the general ledger balance values, to identify a plurality of anomalous general ledger balance values.
(c) identifying the plurality of journal entries associated with each anomalous general ledger balance value;
(d) performing a clustering analysis on the plurality of journal entries associated with each anomalous general ledger balance value to identify a common characteristic amongst two or more of the plurality of journal entries associated with each anomalous general ledger balance value;
(e) receiving a predictive characteristic;
(f) comparing the common characteristic with the predictive characteristic to identify a correlation between the common characteristic and the predictive characteristic; and
(g) reporting the common characteristic as indicating a risk of material misstatement due to financial reporting fraud, if a correlation is identified.

34. The method of claim 33, wherein receiving a predictive characteristic comprises deriving the predictive characteristic by performing steps (a)-(d) on a second plurality of general ledger balance values and a second plurality of journal entries associated with each of the second plurality of general ledger balance values, the second pluralities of general ledger balance values and journal entries being obtained from a business entity where financial reporting fraud has previously occurred.

35. A method of identifying risks of material misstatement due to financial reporting fraud, comprising:
(a) receiving a plurality of general ledger balance values and a plurality of journal entries associated with each general ledger balance value, each journal entry having a characteristic;
(b) performing a multivariate regression analysis on the general ledger balance values, to identify a plurality of anomalous general ledger balance values.
(c) identifying the plurality of journal entries associated with each anomalous general ledger balance value;
(d) performing a decision tree analysis on the plurality of journal entries associated with each anomalous general ledger balance value to identify a rule that describes two or more of the plurality of journal entries associated with each anomalous general ledger balance value;
(e) receiving a predictive rule;
(f) comparing the rule with the predictive rule to identify a correlation between the rule and the predictive rule; and
(g) reporting the rule as indicating a risk of material misstatement due to financial reporting fraud, if a correlation is identified.

36. The method of claim 35, wherein receiving a predictive rule comprises deriving the predictive rule by performing steps (a)-(d) on a second plurality of general ledger balance values and a second plurality of journal entries associated with each of the second plurality of general ledger balance values, the second pluralities of general ledger balance values and journal entries being obtained from a business entity where financial reporting fraud has previously occurred.

37. A method for detecting a recurrence in a data collection of a historical characteristic, comprising:
receiving the historical characteristic;
receiving the data collection, comprising a plurality of data items;
identifying a plurality of anomalous data items in the plurality of data items;
identifying a common characteristic of the plurality of anomalous data items; and
comparing the common characteristic with the historical characteristic, to identify the recurrence of the historical characteristic.

38. The method of claim 35, wherein the historical characteristic comprises a characteristic indicative of fraud.

39. The method of claim 35, wherein the historical characteristic comprises a characteristic indicative of money laundering.

40. The method of claim 35, wherein the historical characteristic comprises a characteristic indicative of unusually low tax payments.

41. The method of claim 35, wherein the historical characteristic comprises a characteristic indicative of unusually high numbers of third-party transactions.

42. A system for detecting fraud, comprising:
an input data receiver, adapted to receive financial data comprising a plurality of data points, each of the plurality of data points having a value and an associated characteristic;
a statistical analyzer, adapted to analyze the plurality of data points to identify a plurality of anomalous data points;
an artificial intelligence analyzer, adapted to identify a common characteristic associated with the anomalous data points;
a data comparator, adapted to receive a fraud predictive characteristic, compare the common characteristic with the fraud predictive characteristic, and determine a likelihood of fraud based on the results of the comparison; and
an output data provider, adapted to provide output data suggesting the presence of fraud.

43. The system of claim 42, wherein the artificial intelligence analyzer is adapted to apply a clustering algorithm to the anomalous data points.

44. The system of claim 42, wherein the artificial intelligence analyzer is adapted to apply a decision tree algorithm to the anomalous data points.

45. The system of claim 42, wherein the artificial intelligence analyzer is adapted to apply a rule induction algorithm to the anomalous data points.

46. The system of claim 42, wherein the statistical analyzer, the artificial intelligence analyzer and the data comparator are adapted to iteratively process the plurality of data points.

47. The system of claim 46, wherein the iterative process is adapted to select a data point to process based at least in part on a result of a prior iteration of the iterative process.

48. The system of claim 47, wherein the result comprises a determination that fraud is likely in the data point analyzed in the prior iteration.

49. The system of claim 42, further comprising a data storage device, adapted to store one or more of the financial data and the fraud predictive characteristic.

50. The system of claim 42, wherein the system is used in connection with forensic and investigative accounting.

51. A method of detecting fraud, comprising:
(a) receiving a plurality of general ledger balance values and a plurality of journal entries associated with each general ledger balance value, each journal entry having a characteristic;
(b) performing a statistical analysis on the general ledger balance values, to identify a plurality of anomalous general ledger balance values.
(c) identifying the plurality of journal entries associated with each anomalous general ledger balance value;
(d) performing a clustering analysis on the plurality of journal entries associated with each anomalous general ledger balance value to identify a common characteristic amongst two or more of the plurality of journal entries associated with each anomalous general ledger balance value;
(e) receiving a fraud predictive characteristic;
(f) comparing the common characteristic with the fraud predictive characteristic to identify a correlation between the common characteristic and the predictive characteristic; and
(g) reporting the common characteristic as indicating a possibility of financial reporting fraud, if a correlation is identified.

52. The method of claim 33, wherein receiving a fraud predictive characteristic comprises deriving the fraud predictive characteristic by performing steps (a)-(d) on a second plurality of general ledger balance values and a second plurality of journal entries associated with each of the second plurality of general ledger balance values, the second pluralities of general ledger balance values and journal entries being obtained from a business entity where financial reporting fraud has previously occurred.

53. A system for identifying risks of material misstatement due to fraud, comprising:
a means for receiving input data, comprising a plurality of data points, each of the plurality of data points having a value and an associated characteristic;
a means for analyzing the input data to identify a plurality of anomalous data points;
a means for analyzing the plurality of anomalous data points to identify a common characteristic associated with the anomalous data points;
a means for receiving a predictive characteristic,
a means for comparing the common characteristic with the predictive characteristic;
a means for determining a likelihood of risks of material misstatement due to fraud based on the results of the comparison; and
a means for providing output data suggesting a risk of material misstatement due to fraud, based on the determination of the likelihood of risks of material misstatement due to fraud.

54. The system of claim 53, wherein the means for analyzing the input data comprises a means for conducting a statistical analysis on the input data.

55. The system of claim 53, wherein the means for analyzing the plurality of anomalous data points comprises a means for conducting an artificial intelligence analysis on the input data.

56. The system of claim 55, wherein the artificial intelligence analysis comprises a clustering algorithm based analysis.

57. The system of claim 53, wherein the artificial intelligence analysis comprise a decision tree algorithm based analysis.
